(19) United States
(12) Patent Application Publication
(10) Pub. No.: US 2007/0022467 A1
(43) Pub. Date: Jan. 25, 2007

(54) Method and system for limiting access to a shared network device

(76) Inventor: Walter Filbrich, Manhattan Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/187,645

(22) Filed: Jul. 22, 2005

(51) Int. Cl. H04L 9/32; H04L 9/00; H04K 1/00; G06K 9/00; G06F 17/30; G06F 7/04

(52) U.S. Cl. 726/2; 713/182; 713/183; 713/184

(57) ABSTRACT

A system and method for limiting access to shared network devices only to authorized users is disclosed. First, access information associated with authorized users is stored in a memory of a network device. When a user enters a command to the network device from a networked computer, the user is asked to enter unique access information such as a user name and password. The user name and password is transmitted to the network device with the command. The network device determines whether the user name and password matches one of those stored in its memory. If there is a match, the command is processed by the network device. If no match is found, the command is discarded.

### BACKGROUND OF THE INVENTION

1. Field of the Invention

The invention relates to use of shared network devices in a computer network environment. More particularly, the invention relates to limiting access to network devices only to authorized users.

2. Description of the Related Technology

Recently, many computers and computerized terminals are networked via various forms of information networks. Also, computerized equipment and various computer peripheral devices are networked with computers. One purpose of networking such computerized devices is to allow many users of the networked computers to share the devices. On the other hand, there is a need to limit the access to network devices only to certain users.

There are some known schemes for limiting access to network devices by only authorized users. One scheme is allowing only specific computers to access network devices. Another scheme is blocking access to network devices from specific computers. Still another scheme is connecting devices to the network and allowing authorized users to access the device via a network server or a computer. A further scheme is adding an external device such as a card reader to enable the network device only when an authorized card is swiped.

### SUMMARY OF CERTAIN INVENTIVE ASPECTS

One aspect of the invention provides a method of operating a networked printing device. The method may comprise providing a networked printing device and receiving an instruction for operating the device via a network, to which the device is connected. The device may comprise a memory storing a list of access information associated with authorized users. The instruction may comprise access information associated with a particular user. The method further may comprise determining whether the particular user's access information is contained in the stored list and processing the instruction if the particular user's access information is contained in the list.

The foregoing method may further comprise discarding the instruction if the particular user's access information is not contained in the list. The access information may comprise at least one of a user name and a password. The instruction may comprise the particular user's access information in a header section thereof. The method may further comprise identifying the particular user's access information from the instruction before the determining step. The instruction may further comprise information indicative of the end of the instruction. The device may comprise a multi-functional printer (MFP). The instruction may comprise a print job. The providing the device may comprise updating the list stored in the memory. The device may comprise an embedded web server comprising a page for updating the list, and wherein updating the list may be carried out on the page. The page may be accessible from any computing device connected to the network. The page may be password-protected.

Another aspect of the invention provides a printing device, which comprises: means for storing a list of access information associated with authorized users and means for receiving an instruction for operating the device via a network to which the device is connected. The instruction comprises access information associated with a particular user. The device further comprises means for determining whether the particular user's access information is contained in the stored list and means for processing the instruction if the particular user's access information is contained in the list.

Another aspect of the invention provides a printing device, which comprises a memory configured to store a list access information associated with authorized users and a processor configured to determine validity of an instruction to operate the device upon receipt of the instruction via a network, by identifying access information a particular user from the instruction and determining whether the particular user's access information is contained in the list.

In the foregoing printing device, the processor may be further configured to process the instruction if the instruction is valid. The processor may be further configured to discard the instruction if the instruction is not valid. The processor may be further configured to determine the end of the instruction. The device may comprise a multi-functional printer. The instruction may comprise a header section comprising the access information of the particular user. The authorized users' access information may comprise at least one of a user name and a password. The device may comprise an embedded web server comprising a page for updating the list, and wherein the list stored in the memory can be updated on the page. The page may be accessible from any computing device connected to the network. The page may be password-protected.

A further aspect of the invention provides a method of instructing a networked printing device. The method comprises: creating an instruction for operating a printing device connected to a network using a computing device connected to the network; adding access information of a particular user to the instruction; and transmitting the instruction to the device. Prior to processing the instruction, the device determines the validity of the instruction by verifying the particular user's access information.

In the foregoing method, the device may store a list of access information associated with authorized users. Verifying the particular user's access information may comprise comparing the access information to that of authorized users'. The device may comprise a multi-functional printer. The instruction may comprise a print job, and wherein the print job may comprise the particular user's access information in a header thereof.

### BRIEF DESCRIPTION OF THE DRAWINGS

FIG. 1 schematically illustrates a network environment in which embodiments of the invention can be implemented.

FIG. 2 is a block diagram of a shared network device in accordance with an embodiment.

FIG. 3 is a flowchart of the setup for limiting access to the network device in accordance with an embodiment.

FIG. 4 is a flowchart of storing user names of authorized users of the network device using an embedded web server of the network device in accordance with an embodiment.

FIG. 5 is a computer screen display showing the user authentication page of the embedded web server in accordance with an embodiment.

FIG. 6 is a flowchart of operation of the system and method to limit access to a network printer in accordance with an embodiment.

FIG. 7 is an exemplary print job including header commands, data to print and an end of job command, including a user name and a password in the header commands.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

Network Environment

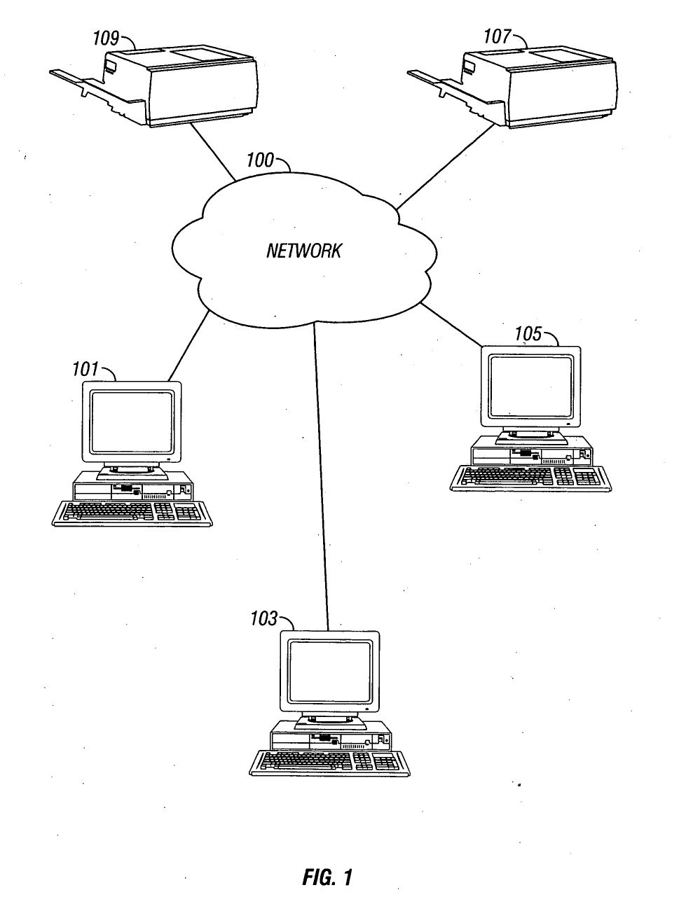

FIG. 1 illustrates a network environment in which an embodiment of the invention can be implemented. In the illustrated embodiment, networked computing devices 101, 103, 105 and network devices 107, 109 are connected to the network 100. In this network environment, users of the networked computing devices 101, 103, 105 can share the network devices 107, 109. In other words, the users of the networked computing devices 101, 103, 105 can access the network devices 107, 109 via the network 100 and process certain tasks using the network devices 107, 109 even though these devices are not locally connected to the networked computing devices 101, 103, 105.

In the illustrated embodiment, the network 100 can be any form of information network interconnecting various computers, computerized devices and network devices. The network 100 may have either or both wired and wireless connections. The networked computing devices 101, 103, 105 represent any computerized devices that can provide commands to another device, e.g. printers connected to the network 100. Such computerized devices include, for example, desktop computers, laptop computers, network servers, handheld computers, smartphones, etc. The network devices 107, 109 represent any devices that can be shared by the networked computing devices 101, 103, 105. Such network devices include, for example, printers, scanners, facsimile machines, photocopiers, and multi-functional printers (MFPs) having a combination of at least two of the following functions: printing, scanning and facsimile.

Shared Network Device

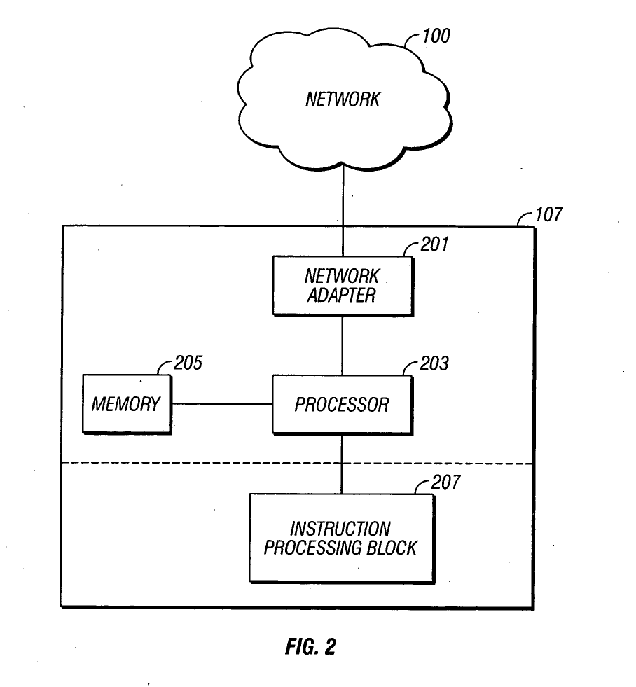

FIG. 2 illustrates a schematic block diagram of a network device such as a printer of an embodiment of the invention. The device 107 has a network adaptor 201 for providing an interface between the remaining components of the device 107 and the network 100 to which the device 107 is connected. The network adaptor 201 may have a wired or wireless connection to the network 100. In the illustrated embodiment, the device 107 includes a processor 203, a memory 205, and an instruction processing block 207.

In the illustrated embodiment, the memory 205 stores identification information of the users who are authorized to access and use the device 107. In some embodiments, the memory is a rewritable memory or a read-only memory having pre-stored data and optionally programs. In one embodiment, the memory 205 is a non-volatile memory, such as a hard disk drive, a non-volatile random access memory (RAM), a flash memory, etc. In other embodiments, the memory 205 may be a volatile memory, in which each user's authorized identification information is stored at least while the device 107 is operating. In one embodiment of the volatile memory, the authorized identification information is copied to the memory 205 from another source when or soon after the device 107 is powered up.

The instruction processing block 207 is designed to process task instructions that are received from the network 100. Although not illustrated in detail, the instruction processing block 207 may include its own processor, memory, and other components. In some embodiments, the processor 203 and the processor of the block 207 may be implemented in a single chip or in separate chips. Also, the memory 205 and the memory of the block 207 may be implemented in a single memory device or as separate memory devices.

In the illustrated embodiment, when a command or an instruction to process a task is transmitted from a computing device to the network device 107, the processor 203 determines whether the instruction is valid using the authorized identification information stored in the memory 205. If the instruction is determined to be valid, the instruction is transferred to the instruction processing block 207 for processing, for example printing certain data. If the instruction is determined to be invalid, the instruction is discarded. The processes for determining the validity of the instruction will be described in more detail.

Setup for Limiting Access to Network Device

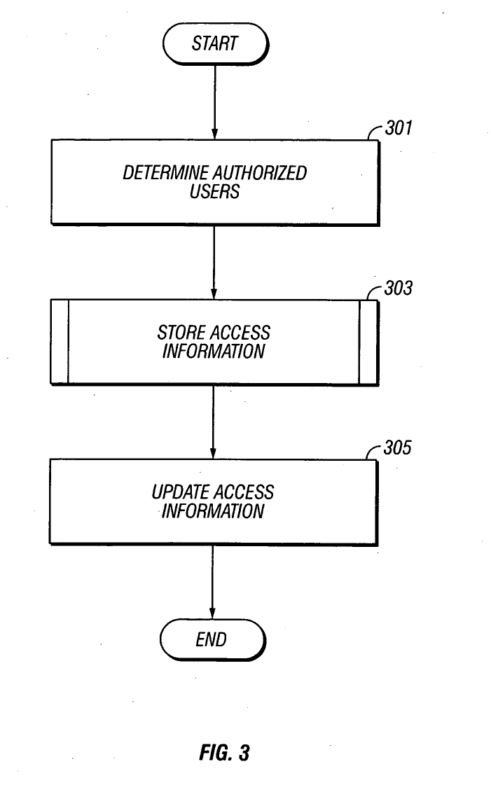

FIG. 3 illustrates an embodiment of a procedure for setting up a network device 107 to limit access only to authorized users. First, in step 301, authorized users of a network device are determined. In one embodiment, a network administrator can determine who should have the access to the network devices. In another embodiment, an office administrator can provide a list of current employees, who should have the access to the network devices. The authorized users may be the same for all of the network devices. Alternatively, the authorized users may differ from device to device, in which multiple lists of the authorized users can be provided.

Subsequently, in step 303, access information such as a “identification information” (hereinafter “ID”) of the authorized users is stored in the memory 205 of the network device 107. If the memory 205 is volatile, the user ID can be stored in a non-volatile memory (not shown) that can be accessed by the volatile memory 205 when the device 107 is powered up. The user ID is any information that can identify an authorized user and also is recognizable by the processor 203 of the device 107. Typically, user ID consists of a string of alpha-numeric characters that can be directly accessed via a standard PC keyboard. Other access information that is unique to a user may be biometric data including, for example, fingerprint, hand, voice and retinal data. In one embodiment, the access information consists of one piece of information for each authorized user, such as user name or login name. To improve the security of the system, in other embodiments, the two or more pieces of access information may be used for each authorized user. For example, a password or passcode may be associated with each user name or login name.

Once the access information has been stored in the memory 205, the access information may be updated as in step 305. For example, the existing access information may be deleted or changed. Also, new access information may be added.

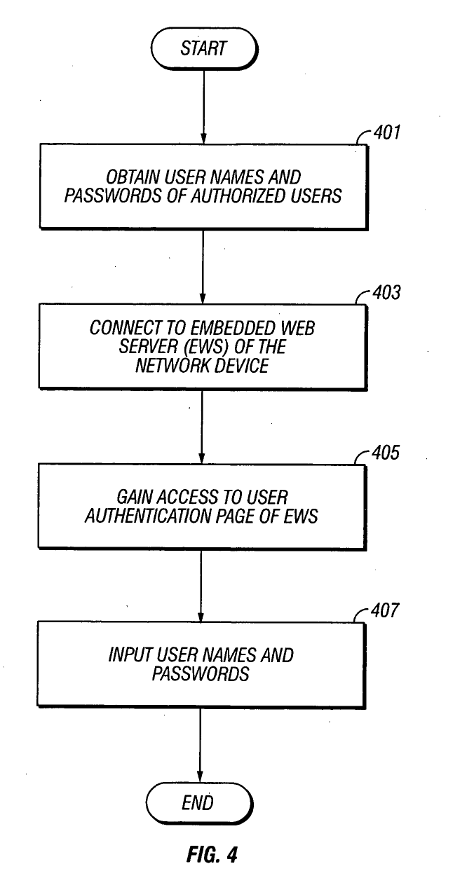

It is notable that there are numerous ways to store the user ID information in the memory 205 of the network device 207. Such other methods will be readily appreciated by one of ordinary skill in the art. FIG. 4 illustrates an embodiment of the step 303 for storing access information using an embedded web server of the network device. In this embodiment of FIG. 4, the access information includes a user name and a password.

In the illustrated embodiment, in step 401, user names and passwords of authorized users who are determined in step 301 are obtained. An administrator, e.g., a network administrator, who stores the information can ask each authorized user to provide a user name and a password, and collect them. Alternatively, the network administrator may create arbitrary user names and passwords for the authorized users.

Once the user names and passwords are obtained, in step 403, the network administrator connects to an interface of the network device 107, through which the obtained user names and passwords can be stored in the memory 205. In the illustrated embodiment, the network administrator connects to the embedded web server of the network device 107. As will be understood by those having ordinary skill in the relevant technology, the embedded web server (not illustrated) is part of the network device 107 and emulates a web site on the network device. In one embodiment, the network administrator can connect to the embedded web server from one of the networked computing devices by providing the URL address of the embedded web server of the printer 107 to a network browser.

Next, in step 405, the network administrator gains access to the user authentication page of the embedded web server. Typically, the user authentication page is password-protected and can be accessed only by pre-registered users, such as network administrators. Once the user authentication page is opened, in step 407, the network administrator inputs the user names and passwords of the authorized users of the network device 107. The user names and passwords which have been input are stored in the memory 205 of the network device.

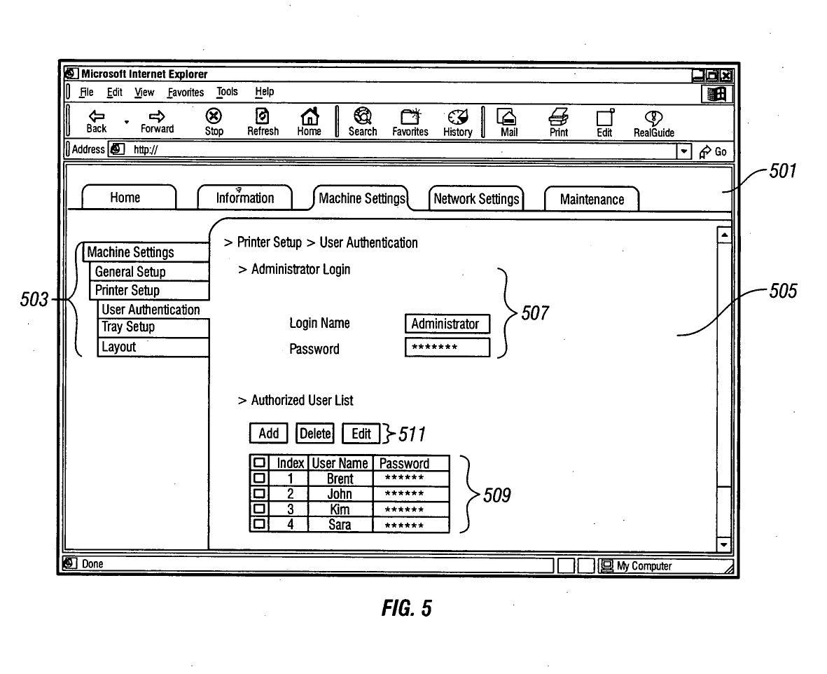

FIG. 5 illustrates an exemplary user authentication page in one embodiment of the embedded web server of a network printer. As indicated by reference number 501, the embedded web server has various pages, which are generally categorized as “home,” “information,” “machine settings,” “network settings” and “maintenance.” In the illustrated screen, the category, machine settings, is selected. As indicated by reference number 503, the machine settings category has sub-categories, which are “general setup” and “printer setup.” Under the printer setup, there are pages for “user authentication,” “tray setup” and “layout.” In this illustrated embodiment, user authentication page 505 is opened. The reference number 507 indicates the administrator log-in section. Only when the network administrator inputs a valid combination of login name and password does the administrator gain full access to the user authentication page which permits storage of the access information associated with the authorized users. The network administrator who has obtained the access can create or modify the list or table 509 of the authorized users, using the add, delete and edit buttons 511.

In the embodiment illustrated in FIGS. 4 and 5, the user names and passwords are stored by the network administrator, not by each of the authorized users. However, in other embodiments, the authorized users may directly store their user names and passwords in the memory 205. In such embodiments, the step 401 of obtaining user names may not be needed. In one of such embodiments, each authorized user may access the user authentication page of the embedded web server and list his or her user name and password.

Limiting Access to a Network Printer

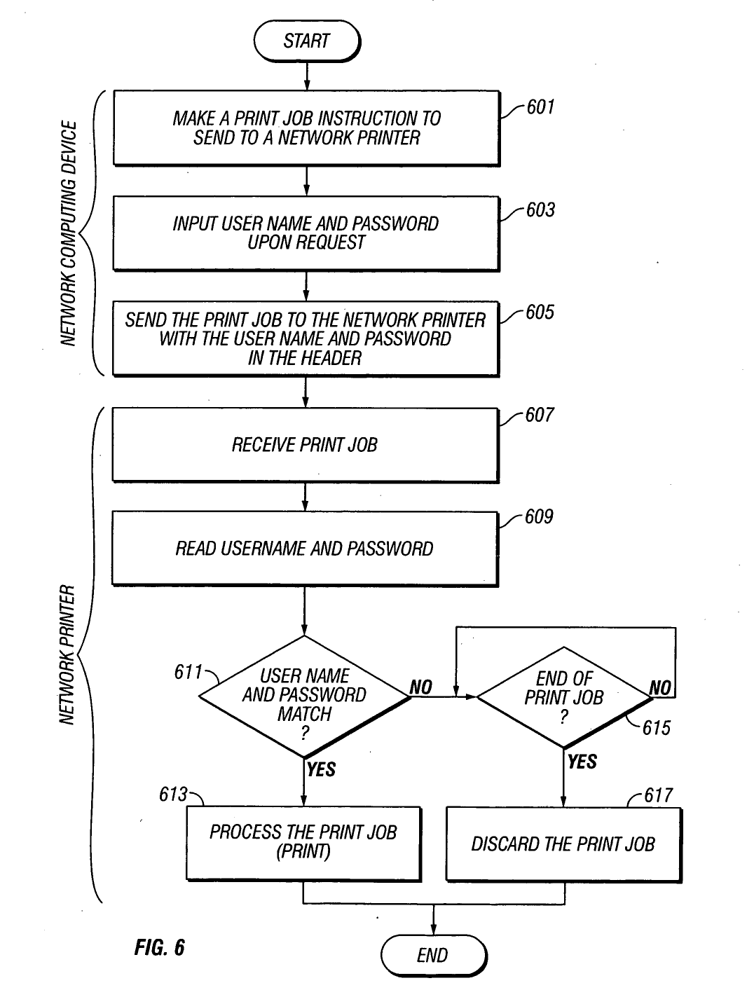

FIG. 6 illustrates an embodiment of the process for limiting access to a network device only to authorized users. In the illustrated embodiment, the network device 107 of FIG. 2 is a printer and its instruction processing block 207 is a printing block. Although not described, similar process will apply to other types of shared network devices. A skilled technologist will appreciate appropriate and/or necessary modifications in network devices other than a printer.

First, in step 601, a user of a networked computing device initiates a command to a network printer 107. For example, the user points the cursor to a print icon of a word processing program on the computer screen and forwards a print command by clicking the mouse. Before or after this printing instruction, the user may need to select the printer 107.

Then, in step 603, the computing device asks for the user to input his/her user name and password for proceeding to the printing, and the user inputs a user name and a password. In one embodiment, the printer driver software installed in the computing device opens a dialog box requiring the user to enter a user name and a password. In response, the user inputs a string of alpha-numeric characters as a user name and a password. In one embodiment, the computing device may automatically provide the printer driver software with the user name or logon name that was used by the same user in logging onto the network. Then, the user simply inputs their password.

Subsequently, in step 605, the computing device sends the printing instruction (called print job) with the user name and password to the network printer 107. The user name and password can be communicated to the network printer 107 in various formats. More particularly, in the illustrated embodiment, the user name and password are included in the header of the print job. The header is generated by the printer driver program and contains various commands to the network printer in a format readable by the network printer 107. For example, the header may be created using industry standard commands, such as Printer Job Language (PJL) commands. The print job also contains data to print in a format that can be identified by the network printer 107, for example, using an industry standard such as PostScript and PCL page description languages.

Moving to step 607, the network printer 107 receives the print job containing the user name and password. Next, in step 609, the processor 203 of the network printer 107 decodes the header and identifies the user name and password. In decoding the header, the network printer 107 applies functionality from the same industry standard that was used in creating the header. Subsequently at 611, the processor 203 determines whether the user name and password from the received print job are a match to one of the authorized users that is stored in the memory 205. If there is a matching combination (Yes at 611), it is assumed that the print job was sent by an authorized user of the network printer 107. Then, the processor 203 instructs the instruction processing block 207 to process the print job, and an output is generated in step 613. If there is no match (No at 611), it is assumed that the print job was sent by an unauthorized user.

Then, in step 615, the processor 203 begins a process to find the end of the print job, which continues until the end of the print job is found. The end of the print job can be found when there is a command indicating that it is the end of the print job. Alternatively, the end of the print job can be found when a new print job is received from the network 100. Still alternatively, the end of the print job may be found when there is no more data or information to process for an extended period of time, for example for a few minutes. When the end of job is found, the processor discards the entire print job in step 617.

Print Job Example

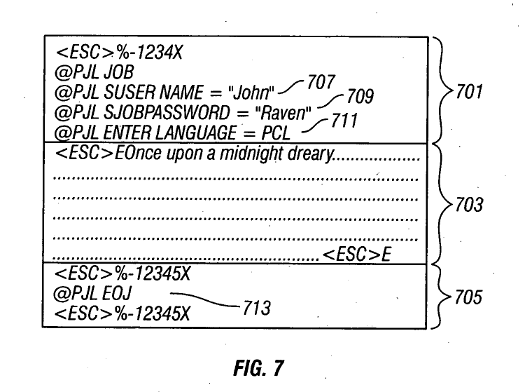

FIG. 7 illustrates an exemplary print job 700 including the user name and password in the header according to an embodiment. The illustrated print job 700 consists of three components, which are a header 701, data for printing 703 and an end of job command section 705. In the illustrated embodiment, the header 701 and end of job command section 705 are written in Printer Job Language (PJL). The data for printing 703 is provided in the PCL page description language which will be understood by those who are familiar with such technology.

The header 701 includes PJL command lines 707 and 709 for user name and password. In order to distinguish from existing standard PJL commands (@PJL USER NAME and @PJL PASSWORD), new PJL commands for the user name and password of authorized printer users are used in the illustrated embodiment. The new PJL command 707 for user name of authorized printer users is, for example, “@PJL SUSER NAME.” The new PJL command 709 for password of authorized printer users is, for example, “@PJL SPASSWORD.” According to the commands 707, 709, this print job 700 was sent by a user named “John” with the password “Raven.”

The network printer 107 and the printer driver software installed in each computing device needs to be updated to use and recognize these new commands 707, 709. The printer driver software of the computing devices adds the command lines 707, 709 to the header when the user inputs his/her user name and password in step 603 described above.

As noted above, the data for printing 703 is provided in the PCL page description language. In fact, in the illustrated embodiment, the command 711 of the header 701 dictates that the language is the PCL page description language. Once the processor 203 of the network printer 107 determines that both the user name and password are valid, the instruction processing block 207 proceeds to print the data for printing 703. In the illustrated embodiment, for example, printed data is “Once upon a midnight dreary . . . .”

In the illustrated embodiment, the end of job command section 705 is added to guarantee that the user name and password are associated with a single print job. Again, the end of job command 713 is written in the PJL command format. Although useful, the end of job command section 705 may not be included in the print job of some embodiment. In such embodiments, as discussed above, the processor 203 may determine the end of the print job by finding the start of a new print job or from no incoming print job or data for a certain period of time.

With the foregoing features and embodiments, an unauthorized person's use of network devices is effectively inhibited while authorized users can access and use network devices from any computing devices. Also, the features of the invention allow that network devices can be connected to any node of the network. No key cards or other external devices are required. No special hardware or software is required to enter the list of authorized users. Authorization of users can be administrated remotely from the network device, although not limited thereto.

It is to be understood that one of ordinary skill in the appropriate art may modify the invention here described while still achieving the favorable results of this invention. Accordingly, the description is to be understood as being a broad, teaching disclosure directed to persons of skill in the appropriate arts, and not as limiting upon the invention.

What is claimed is:

1. A method of operating a networked printing device, the method comprising:
providing a networked printing device comprising a memory storing a list of access information associated with authorized users;
receiving an instruction for operating the device via a network, to which the device is connected, the instruction comprising access information associated with a particular user;
determining whether the particular user's access information is contained in the stored list; and
processing the instruction if the particular user's access information is contained in the list.

2. The method of claim 1, further comprising discarding the instruction if the particular user's access information is not contained in the list.

3. The method of claim 1, wherein the access information comprises at least one of a user name and a password.

4. The method of claim 1, wherein the instruction comprises the particular user's access information in a header section thereof.

5. The method of claim 1, further comprising identifying the particular user's access information from the instruction before the determining step.

6. The method of claim 1, wherein the instruction further comprises information indicative of the end of the instruction.

7. The method of claim 1, wherein the device comprises a multi-functional printer (MFP).

8. The method of claim 1, wherein the instruction comprises a print job.

9. The method of claim 1, wherein providing the device comprises updating the list stored in the memory.

10. The method of claim 9, wherein the device comprises an embedded web server comprising a page for updating the list, and wherein updating the list is carried out on the page.

11. The method of claim 10, wherein the page is accessible from any computing device connected to the network.

12. The method of claim 10, wherein the page is password-protected.

13. A printing device, comprising:
means for storing a list of access information associated with authorized users;
means for receiving an instruction for operating the device via a network to which the device is connected, the instruction comprising access information associated with a particular user;
means for determining whether the particular user's access information is contained in the stored list; and
means for processing the instruction if the particular user's access information is contained in the list.

14. A printing device, comprising:
a memory configured to store a list access information associated with authorized users;
a processor configured to determine validity of an instruction to operate the device upon receipt of the instruction via a network, by identifying access information a particular user from the instruction and determining whether the particular user's access information is contained in the list.

15. The device of claim 14, wherein the processor is further configured to process the instruction if the instruction is valid.

16. The device of claim 14, wherein the processor is further configured to discard the instruction if the instruction is not valid.

17. The device of claim 14, wherein the processor is further configured to determine the end of the instruction.

18. The device of claim 14, wherein the device comprises a multi-functional printer.

19. The device of claim 14, wherein the instruction comprises a header section comprising the access information of the particular user.

20. The device of claim 14, wherein the authorized users' access information comprises at least one of a user name and a password.

21. The device of claim 14, wherein the device comprises an embedded web server comprising a page for updating the list, and wherein the list stored in the memory can be updated on the page.

22. The device of claim 21, wherein the page is accessible from any computing device connected to the network.

23. The method of claim 21, wherein the page is password-protected.

24. A method of instructing a networked printing device, the method comprising:
creating an instruction for operating a printing device connected to a network using a computing device connected to the network;
adding access information of a particular user to the instruction; and
transmitting the instruction to the device, wherein prior to processing the instruction, the device determines the validity of the instruction by verifying the particular user's access information.

25. The method of claim 24, wherein the device stores a list of access information associated with authorized users.

26. The method of claim 24, wherein verifying the particular user's access information comprises comparing the access information to that of authorized users'.

27. The method of claim 24, wherein the device comprises a multi-functional printer.

28. The method of claim 24, wherein the instruction comprises a print job, and wherein the print job comprises the particular user's access information in a header thereof.
